(19) United States
(12) Patent Application Publication
(10) Pub. No.: US 2026/0297455 A1
(43) Pub. Date: Oct. 1, 2026

(54) DISSOLVABLE DRINKWARE CLEANING FORMULATION

(71) Applicant: Savior Products, Inc., Lenexa, KS (US)

(72) Inventors: Brock Templeman, Overland Park, KS (US); Jon Templeman, Overland Park, KS (US)

(21) Appl. No.: 19/636,435

(22) Filed: Apr. 1, 2026

Related U.S. Application Data
(60) Provisional application No. 63/781,648, filed on Apr. 1, 2025.

(51) Int. Cl. C11D 1/10; C11D 3/04; C11D 3/10; C11D 3/37; C11D 17/00

(52) U.S. Cl. CPC C11D 1/10; C11D 3/042; C11D 3/046; C11D 3/10; C11D 3/3707; C11D 17/0047; C11D 2111/20

(57) ABSTRACT

A cleaning composition for cleaning a drinking vessel is configured to dissolve in water contained within the drinking vessel and generate fluid agitation sufficient to clean interior surfaces without mechanical scrubbing. The cleaning composition comprises an oxidizing agent, sodium carbonate, a weak acid, a chelating agent, a surfactant, and a binder. The composition includes a dual gas-generating system configured to generate a first gas from reaction of the weak acid and sodium carbonate and a second gas from the oxidizing agent, wherein the combined gas generation produces fluid agitation and circulation within the drinking vessel. The surfactant facilitates removal of organic residues and the chelating agent binds mineral deposits. In some embodiments, the relative amounts of the components are selected to provide effective gas generation while maintaining desired regulatory and handling characteristics.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/781,648; titled “DISSOLVABLE DRINKWARE CLEANING FORMULATION”; and filed Apr. 1, 2025. The Provisional Application is hereby incorporated by reference, in its entirety, into the current patent application.

### FIELD OF THE INVENTION

Embodiments of the present invention relate generally to cleaning compositions, and more particularly to dissolvable cleaning compositions for cleaning drinking vessels, including compositions comprising gas-generating systems configured to induce fluid agitation within a liquid contained in the drinking vessel.

### BACKGROUND OF THE INVENTION

Many drinking vessels or containers are too large to fit in the top racks of conventional dishwashers and therefore must either be placed in the bottom racks, where they occupy excessive space and increase water, detergent, and energy consumption, or be washed by hand. Some drinking containers, such as hydration bladders, insulated vessels, and painted or coated containers, are not dishwasher safe and must be washed manually. Hand washing is time consuming, often requires significant water and detergent usage, and typically involves the use of brushes or specialized cleaning tools to reach interior surfaces, including narrow or elongated regions.

Various cleaning compositions have been developed for use in cleaning drinking vessels, including dissolvable tablets and powders that generate gas upon contact with water. However, many such compositions rely heavily on oxidizing agents to provide cleaning efficacy and gas generation. Higher concentrations of oxidizing agents can increase cost, raise potential safety and regulatory concerns, and in some cases lead to classification as hazardous materials for transport and storage.

Additionally, existing cleaning compositions often do not generate sufficient fluid agitation within a confined drinking vessel to effectively circulate cleaning solution throughout the interior volume. As a result, cleaning action may be limited to regions immediately adjacent to the cleaning composition, leaving other interior surfaces insufficiently cleaned without manual scrubbing or agitation.

Accordingly, there is a need for improved cleaning compositions for drinking vessels that can provide effective cleaning performance without requiring high concentrations of oxidizing agents, while generating sufficient fluid agitation to contact interior surfaces throughout the vessel without mechanical scrubbing.

The background discussion is intended to provide information related to the present invention and is not necessarily prior art.

### SUMMARY OF THE INVENTION

Embodiments of the present invention provide a cleaning composition for cleaning a drinking vessel, wherein the cleaning composition is configured to dissolve in water contained within the drinking vessel and generate fluid agitation sufficient to clean interior surfaces without mechanical scrubbing.

In some embodiments, the cleaning composition comprises an oxidizing agent, sodium carbonate, a weak acid, a chelating agent, a surfactant, and a binder. The cleaning composition comprises a dual gas-generating system configured to generate a first gas from reaction of the weak acid and sodium carbonate and a second gas from the oxidizing agent.

In some embodiments, the dual gas-generating system is configured to generate carbon dioxide gas from reaction of the weak acid and sodium carbonate and oxygen gas from the oxidizing agent, thereby producing fluid agitation within a liquid contained in the drinking vessel.

In some embodiments, the oxidizing agent is present below a threshold at which the composition is classified as an oxidizing hazardous material for transport. In some embodiments, a reduction in gas generation from the oxidizing agent is compensated by gas generation from the weak acid and sodium carbonate.

In some embodiments, the weak acid and sodium carbonate are present in proportions approximating stoichiometric equivalence for carbon dioxide gas generation.

In some embodiments, the dual gas-generating system produces circulation within liquid contained in the drinking vessel sufficient to contact interior surfaces not directly adjacent to the cleaning composition.

In some embodiments, the cleaning composition comprises a single surfactant. In some embodiments, the surfactant comprises an amino acid-based surfactant.

In some embodiments, the cleaning composition is provided in a solid form selected from the group consisting of a tablet form, a pellet form, a granular form, a capsule form, a powder form, a solid unit-dose form, a compressed solid form, an effervescent tablet form, a water-soluble packet form, and a sachet form.

In some embodiments, the binder is water-soluble and is configured to maintain the cleaning composition in a solid form prior to use and to dissolve upon contact with water in the drinking vessel, wherein the cleaning composition is configured to dissolve within about 1 to about 15 minutes.

In some embodiments, the oxidizing agent is sodium percarbonate, the weak acid is citric acid, the chelating agent is sodium gluconate, the surfactant is sodium stearoyl glutamate, and the binder is polyethylene glycol.

In some embodiments, the oxidizing agent is present at about 15% to about 35% by weight, the sodium carbonate is present at about 20% to about 45% by weight, and the weak acid is present at about 10% to about 30% by weight.

In some embodiments, the cleaning composition comprises an oxidizing agent constituting about 29% by weight of the composition, sodium carbonate constituting about 35% by weight of the composition, a weak acid constituting about 23% by weight of the composition, a chelating agent constituting about 5% by weight of the composition, a surfactant constituting about 3% by weight of the composition, and a binder constituting about 5% by weight of the composition.

This summary is provided to introduce a selection of concepts in a simplified form that are further described below in the detailed description. This summary is not intended to identify essential features of the claimed subject matter, nor is it intended to limit the scope of the claimed subject matter.

### BRIEF DESCRIPTION OF DRAWINGS

Embodiments of the present invention are described in detail below with reference to the attached drawing figures, wherein:

FIG. 1 is a perspective environmental view of a cleaning composition disposed in a drinking vessel containing water, wherein the cleaning composition is configured to dissolve and generate gas to induce fluid agitation within the drinking vessel for cleaning interior surfaces; and

FIG. 2 is a perspective view of a cleaning composition in the form of a solid, unit-dose tablet.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In general, the present disclosure relates to a cleaning composition configured to dissolve in water contained in a drinking vessel for cleaning the drinking vessel. In various embodiments, the cleaning composition comprises an oxidizing agent, sodium carbonate, a weak acid, a chelating agent, a surfactant, and a binder, and is configured to generate gas upon contact with water to induce fluid agitation within the drinking vessel. The surfactant is configured to assist in removal of organic residues from interior surfaces of the drinking vessel, and the chelating agent is configured to bind mineral deposits present on interior surfaces of the drinking vessel.

In some embodiments, the cleaning composition comprises a dual gas-generating system including a first gas-generating component and a second gas-generating component. The first gas-generating component comprises a weak acid and sodium carbonate configured to react upon dissolution in water to generate a first gas, and the second gas-generating component comprises an oxidizing agent configured to generate a second gas upon dissolution in water.

In some embodiments, the first gas comprises carbon dioxide gas and the second gas comprises oxygen gas. The dual gas-generating system is configured such that the combined gas generation produces fluid agitation within a liquid contained in the drinking vessel.

In some embodiments, the oxidizing agent is present below a threshold at which the cleaning composition would be classified as an oxidizing hazardous material for transport. Reducing the concentration of the oxidizing agent may reduce gas generation from the oxidizing agent. Accordingly, in some embodiments, the dual gas-generating system is configured such that gas generation from the weak acid and sodium carbonate compensates for reduced gas generation from the oxidizing agent, thereby maintaining sufficient total gas generation for effective cleaning.

In some embodiments, the weak acid and sodium carbonate are present in proportions approximating stoichiometric equivalence for carbon dioxide gas generation. In this manner, the composition is configured to generate a controlled and effective quantity of carbon dioxide gas upon dissolution, contributing to the overall gas output of the dual gas-generating system.

In some embodiments, the gas generated by the dual gas-generating system produces fluid agitation and circulation within the liquid contained in the drinking vessel. The fluid agitation is sufficient to move the cleaning composition throughout the interior volume of the drinking vessel, including to contact interior surfaces that are not directly adjacent to the cleaning composition.

The induced fluid agitation and circulation facilitate removal of residues from interior surfaces of the drinking vessel without mechanical scrubbing, including from regions that are difficult to access manually.

In some embodiments, the cleaning composition comprises a single surfactant. The surfactant may comprise an amino acid-based surfactant, such as sodium stearoyl glutamate. The surfactant is configured to assist in removal of organic residues from interior surfaces of the drinking vessel.

In various embodiments, the cleaning composition may be provided in a variety of physical forms suitable for delivery into a drinking vessel containing water. In some embodiments, the cleaning composition is provided in a solid form selected from the group consisting of a tablet form, a pellet form, a granular form, a capsule form, a powder form, a solid unit-dose form, a compressed solid form, an effervescent tablet form, a water-soluble packet form, and a sachet form.

In some embodiments, the cleaning composition is provided as a solid unit-dose form configured to be placed directly into a drinking vessel containing water. In such embodiments, the composition is configured to dissolve upon contact with the water and to generate gas sufficient to induce fluid agitation within the drinking vessel.

In some embodiments, the cleaning composition is provided as a compressed solid form, including a tablet or pellet, formed by compressing the constituent ingredients into a unitary structure. In other embodiments, the cleaning composition may be provided as granules or a powder configured to be introduced into the drinking vessel. In further embodiments, the cleaning composition may be provided within a water-soluble packet or sachet configured to dissolve upon contact with water to release the cleaning composition.

Regardless of the physical form, the cleaning composition is configured to dissolve in water contained in the drinking vessel and to generate gas via the dual gas-generating system to induce fluid agitation and circulation sufficient to clean interior surfaces of the drinking vessel without mechanical scrubbing.

In some embodiments, the binder is water-soluble and is configured to maintain the cleaning composition in a solid form prior to use and to dissolve upon contact with water in the drinking vessel.

In some embodiments, the cleaning composition is configured to fully dissolve within about 1 to about 15 minutes in water.

In some embodiments, the oxidizing agent comprises sodium percarbonate, the weak acid comprises citric acid, the chelating agent comprises sodium gluconate, the surfactant comprises sodium stearoyl glutamate, and the binder comprises polyethylene glycol.

In one exemplary embodiment, the cleaning composition comprises the following components and approximate percentages by weight shown in the table below.

| Ingredient | Percentage |
|---|---|
| Citric Acid | 23% |
| Sodium Carbonate | 35% |
| Sodium Percarbonate | 29% |
| Sodium Gluconate | 5% |
| Polyethylene Glycol | 5% |
| Sodium Stearoyl Glutamate | 3% |

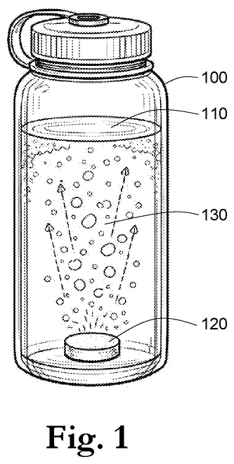

FIG. 1 shows an exemplary drinking vessel 100 containing water 110 and a cleaning composition 120 configured to dissolve in the water 110 to clean the drinking vessel 100. The cleaning composition 120 is positioned within the drinking vessel 100 and generates gas 130 upon contact with the water 110, producing fluid agitation within the drinking vessel.

The generated gas 130 produces agitation and circulation within the water 110, which facilitates distribution of the cleaning composition 120 throughout the interior volume of the drinking vessel 100 and enables contact with interior surfaces without mechanical scrubbing.

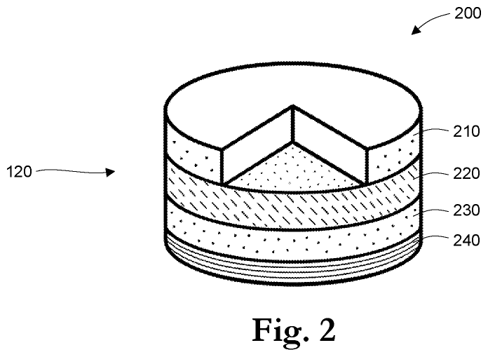

FIG. 2 shows an embodiment of the cleaning composition 120 in the form of a solid, unit-dose tablet 200. The cleaning composition 120 may be formed as a single compressed structure or as a layered structure. As shown, the cleaning composition 120, in the form of a solid, unit-dose tablet 200, includes a top layer 210, a first middle layer 220, a second middle layer 230, and a bottom layer 240. The top layer 210, the first middle layer 220, and the second middle layer 230, and the bottom layer 240 collectively define the cleaning composition 120 and can provide the cleaning composition 120 with a unit-dose structure that maintains the cleaning composition 120 in solid form prior to use.

In various embodiments, the cleaning composition 120 can include an effervescent agent including an acid component and an oxidizing component, a surfactant agent, a chelating agent, and a water-soluble binder, and can further include sodium carbonate, a weak acid, a surfactant, and a binder. These agents can be in any of the layers 210, 220, 230, 240 and even in several of the layers. The top layer 210, the first middle layer 220, the second middle layer 230, and the bottom layer 240 can together define the solid, unit-dose tablet 200 such that the cleaning composition 120 dissolves upon contact with water. Although FIG. 2 illustrates the cleaning composition 120 as a layered tablet the cleaning composition 120 can alternatively be provided in tablet form, pellet form, granular form, capsule form, powder form, compressed solid form, effervescent tablet form, water-soluble packet form, or sachet form.

In operation, the cleaning composition 120 is placed in a drinking vessel 100 containing water 110. Upon contact with the water 110, the cleaning composition 120 dissolves and the dual gas-generating system generates gas 130, producing fluid agitation within the liquid contained in the drinking vessel 100. The generated gas 130 induces circulation within the liquid, which distributes the cleaning composition throughout the interior volume of the drinking vessel 100 and enables contact with interior surfaces without mechanical scrubbing.

The surfactant facilitates removal of organic residues from interior surfaces of the drinking vessel, and the chelating agent binds mineral deposits present on interior surfaces of the drinking vessel, thereby providing effective cleaning.

Throughout this specification, references to “one embodiment”, “an embodiment”, or “embodiments” mean that the feature or features being referred to are included in at least one embodiment of the invention. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A cleaning composition for cleaning a drinking vessel, the cleaning composition comprising:
an oxidizing agent;
sodium carbonate;
a weak acid;
a chelating agent;
a surfactant; and
a binder;
wherein the cleaning composition comprises a dual gas-generating system;
wherein the dual gas-generating system comprises a first gas and a second gas and is configured to generate a first gas from reaction of the weak acid and sodium carbonate and a second gas from the oxidizing agent;
wherein the oxidizing agent is present below a threshold at which the composition is classified as an oxidizing hazardous material for transport; and
wherein the dual gas-generating system produces fluid agitation within a confined drinking vessel sufficient to remove residues without mechanical scrubbing.

2. The cleaning composition of claim 1, wherein a reduction in gas generation from the oxidizing agent is compensated by gas generation from the weak acid and sodium carbonate.

3. The cleaning composition of claim 1, wherein the dual gas-generating system comprises:
a weak acid and sodium carbonate configured to react to generate carbon dioxide gas upon dissolution in water; and
an oxidizing agent configured to generate oxygen gas upon dissolution in water.

4. The cleaning composition of claim 1, wherein the weak acid and sodium carbonate are present in proportions approximating stoichiometric equivalence for carbon dioxide generation.

5. The cleaning composition of claim 1, wherein the dual gas-generating system produces circulation within liquid contained in the drinking vessel sufficient to contact interior surfaces not directly adjacent to the cleaning composition.

6. The cleaning composition of claim 1, wherein the cleaning composition comprises a single surfactant.

7. The cleaning composition of claim 1, wherein the surfactant comprises an amino acid-based surfactant.

8. The cleaning composition of claim 1, wherein the oxidizing agent is present at about 15% to about 35% by weight, wherein the sodium carbonate is present at about 20% to about 45% by weight, wherein the weak acid is present at about 10% to about 30% by weight.

9. The cleaning composition of claim 1, wherein the cleaning composition is in a form selected from the group consisting of a tablet form, a pellet form, a granular form, a capsule form, a powder form, a solid unit-dose form, a compressed solid form, an effervescent tablet form, a water-soluble packet form, and a sachet form.

10. The cleaning composition of claim 1, wherein the binder is water-soluble and configured to maintain the cleaning composition in a sold form prior to use and to dissolve upon contact with the water in the drinking vessel; wherein the cleaning composition is configured to fully dissolve within about 1 to about 15 minutes in water.

11. The cleaning composition of claim 1, wherein the oxidizing agent is sodium percarbonate, wherein the weak acid is citric acid, wherein the chelating agent is sodium gluconate, wherein the surfactant is sodium stearoyl glutamate, and wherein the binder is polyethylene glycol.

12. A cleaning composition for cleaning a drinking vessel, the cleaning composition comprising:
an oxidizing agent constituting about 15-35% by weight of the composition;
sodium carbonate constituting about 20-50% by weight of the composition;
a weak acid constituting about 15-35% by weight of the composition;
a chelating agent constituting about 15-35% by weight of the composition;
a surfactant constituting about 1-10% by weight of the composition; and
a binder constituting about 1-10% by weight of the composition.

13. The cleaning composition of claim 12, wherein the weak acid and sodium carbonate are present in proportions approximating stoichiometric equivalence for carbon dioxide generation.

14. The cleaning composition of claim 12, wherein the cleaning composition comprises a single surfactant.

15. The cleaning composition of claim 12, wherein the surfactant comprises an amino acid-based surfactant.

16. The cleaning composition of claim 12, wherein the cleaning composition is in a form selected from the group consisting of a tablet form, a pellet form, a granular form, a capsule form, a powder form, a solid unit-dose form, a compressed solid form, an effervescent tablet form, a water-soluble packet form, and a sachet form.

17. The cleaning composition of claim 12, wherein the binder is water-soluble and configured to maintain the cleaning composition in a solid form prior to use and to dissolve upon contact with the water in the drinking vessel; wherein the cleaning composition is configured to fully dissolve within about 1 to about 15 minutes in water.

18. The cleaning composition of claim 12, wherein the oxidizing agent is sodium percarbonate, wherein the weak acid is citric acid, wherein the chelating agent is sodium gluconate, wherein the surfactant is sodium stearoyl glutamate, and wherein the binder is polyethylene glycol.

19. A cleaning composition for cleaning a drinking vessel, the cleaning composition comprising:
an oxidizing agent constituting about 29% by weight of the composition;
sodium carbonate constituting about 35% by weight of the composition;
a weak acid constituting about 23% by weight of the composition;
a chelating agent constituting about 5% by weight of the composition;
a surfactant constituting about 3% by weight of the composition; and
a binder constituting about 5% by weight of the composition.

20. The cleaning composition of claim 19, wherein the oxidizing agent is sodium percarbonate, wherein the weak acid is citric acid, wherein the chelating agent is sodium gluconate, wherein the surfactant is sodium stearoyl glutamate, and wherein the binder is polyethylene glycol.

21. The cleaning composition of claim 19, wherein the cleaning composition is in a form selected from the group consisting of a tablet form, a pellet form, a granular form, a capsule form, a powder form, a solid unit-dose form, a compressed solid form, an effervescent tablet form, a water-soluble packet form, and a sachet form.
